(19) United States
(12) Patent Application Publication
(10) Pub. No.: US 2003/0141729 A1
(43) Pub. Date: Jul. 31, 2003

(54) Bumper support, bumper and motor vehicle with bumper

(76) Inventors: Steffen Burkhardt, Herrenberg (DE); Dietmar Preissler, Hagenbuch (DE); Anton Sautner, Treuchtlingen (DE)

Correspondence Address: FULBRIGHT & JAWORSKI, LLP, 666 FIFTH AVE, NEW YORK, NY, 10103-3198, US

(21) Appl. No.: 10/298,165

(22) Filed: Nov. 15, 2002

(30) Foreign Application Priority Data
Nov. 25, 2001 (DE) 101 57 481.9

(51) Int. Cl. B60R 19/34

(52) U.S. Cl. 293/133; 293/155

(57) ABSTRACT

1. Bumper support, bumper and motor vehicle with bumper.

2.1. The invention relates to a bumper for fastening a motor vehicle bumper to a motor vehicle body, the bumper support being configured as a plastically deformable metal part and being provided with creases.

2.2. According to the invention, the bumper is given a box shape.

2.3. For use, for example, in making easy-to-repair motor vehicle bumpers.

The invention relates to a bumper support for attaching a motor vehicle bumper to a motor vehicle body, the bumper support being configured as an energy-absorbing, deformable metal part and being provided with ribbing. The invention also relates to a motor vehicle bumper with a base body and a bumper support according to the invention. The invention furthermore relates to a motor vehicle with a bumper according to the invention.

In German Offenlegungsschrift DE 197 00 022 A1, an energy-absorbing, deformable support for a motor vehicle bumper is disclosed, which is arranged between bumper and body. To permit a controlled deformation of the support in case of a collision, the support is configured as a sheet-metal pot and provided with prescored, rib-like creases. The result is a stable structure and at the same time one of controllable deformation, but one which can be made at comparatively great cost in the form of pressed or drawn sheet metal.

German Auslegeschrift DE 1 289 441 has disclosed a motor vehicle bumper which is fastened to a body by means of a resilient frame. Deformation bodies for energy absorption are arranged above and below the bumper.

With the invention, a more energy-absorbing bumper support is to be created, which combines reliable operation with low manufacturing cost.

According to the invention, a bumper support is provided for connecting a motor vehicle bumper to a motor vehicle body, wherein the bumper support is in the form of a metal part for absorbing energy by deformation and is provided with creases, and wherein the bumper support is in the form of a box section.

Since it is a metal part in the form of a box section, preferably as a deformable sheet-metal piece, the bumper support can on the one hand be manufactured economically, for example as a portion of a box section, and on the other hand, in the event of a collision, it acts as an energy absorber having a defined direction of deformation. Due to its cross section of box section shape, the bumper support is very stiff longitudinally, parallel to its open lateral surfaces, so that it holds the bumper in its 2-position, but is deformable in a defined manner perpendicular thereto.

In further embodiment of the invention, the creases are provided in two opposite walls of the box section metal part and extend between the open sides of the box section metal structure and over the entire width of those walls.

In this manner the creases can be made in a simple manner, for example by bending a strip of sheet metal. By providing the creases in opposite walls, preferably the long sides of the bilaterally open box section, preferably the long sides of the bilaterally open box profile, which in the installed state extend in the direction of an anticipated collision, the result is a reliable, largely defined deformation of the support in case of collision.

The problem to which the invention is addressed is also solved by a motor vehicle bumper with a base body and a bumper support according to the invention, in which the base body has a substantially quadrilateral opening in which the box section of the bumper support is partially inserted, the open sides of the box section support are substantially parallel to the anticipated direction of a collision of the vehicle, a first end wall of the box section metal part, substantially perpendicular to the anticipated direction of a collision, is in contact at least sectionally with a bottom surface of the recess, and the walls of the box-like metal part, which are substantially parallel to the anticipated direction of collision and are provided with creases, are in contact at least sectionally with lateral surfaces of the quadrilateral opening.

By these measures any deflection of the metal part by a collision is prevented, since the walls intended for deformation—appropriately the long sides of the box section of the bumper support—are supported on the outside by the lateral surfaces of the quadrilateral opening. The interior of the quadrilateral opening is available as space for the deformation, so that a maximum possible deformation space is available. At the same time a reliable support in the collision direction is provided since the end wall of the support is in contact at least section-wise with the bottom of the opening. In this manner a reliable fastening of the bumper in normal operation is provided, and the bumper support can be secured on the base body by cotters and/or bolts.

In further embodiment of the invention the base body is of a cage-like configuration in the area of the quadrilateral opening.

In this manner a saving of weight can be achieved without losing strength. For example, the cage can be formed, for example, by lateral or end surfaces of reinforcing ribs of an inner part of the bumper forming the base body.

The problem on which the invention is based is also solved by a motor vehicle with a bumper according to the invention, wherein the vehicle's body has in the bumper area at least one planar end surface that is substantially perpendicular to the anticipated collision direction, while a second end surface of the box section metal part, also substantially perpendicular to the anticipated collision direction, lies flatly against the planar end surface.

In the event of a collision, a secure backing of the bumper support in the direction of collision can be provided by a planar surface on the vehicle's body.

In further embodiment of the invention, the at least single planar surface is provided on a projection extending substantially opposite the anticipated direction of collision.

By providing a projection, the vehicle body is stabilized in the area of the surfaces on which the bumper supports lie, and furthermore a certain space is created between the surface of the body and the bumper. This can prevent the body from also being distorted when the bumper support is collapsed.

In further embodiment of the invention, the end surface is provided with a first bore, and the second end wall of the box section metal part flatly engaging the end surface is provided with a second bore, in order to accommodate a bolt, the first and/or the second bore being of such size that the bolt can be accommodated with free plan in the first and/or second bore.

By these measures it is easy to compensate for differences before tightening the bolt. The first and/or second bore can also be in the form of a slot.

Lastly, it is provided that the diameter of the first bore is about twice the diameter of the bolt.

By these features it is possible to achieve a reliable assembly of the bumper support on the car body while compensating the differences which normally occur between them.

Additional features and advantages of the invention will be found in the claims and the following description of a preferred embodiment of the invention. In the drawings,

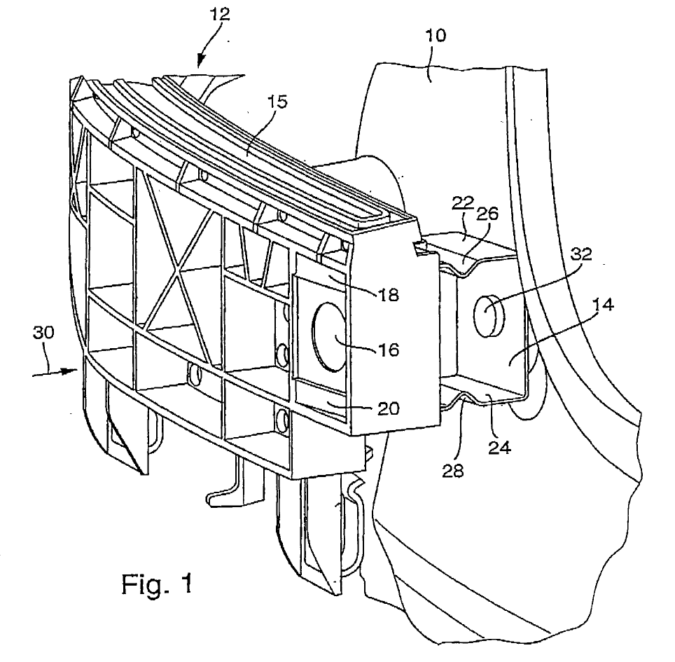

FIG. 1 shows a perspective view of a motor vehicle bumper according to the invention with the bumper cover removed,

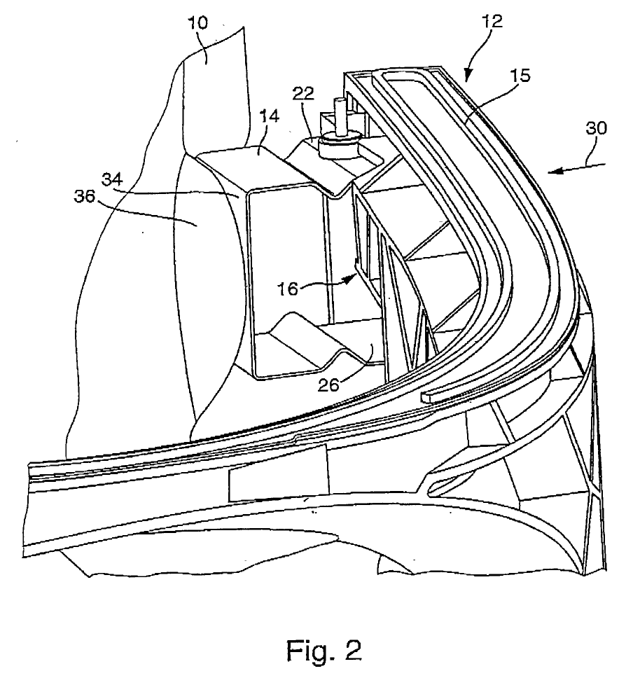

FIG. 2 another perspective view of the motor vehicle bumper according to the invention with the bumper cover removed,

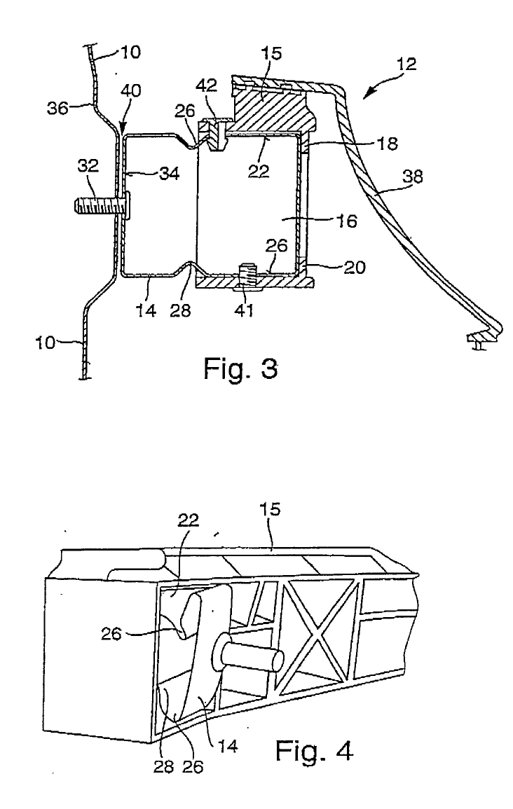

FIG. 3 a detail in elevation of the motor vehicle bumper according to the invention, and

FIG. 4 a perspective detail of the motor vehicle bumper according to the invention after a collision.

In FIG. 1 is seen a section of a motor vehicle body 10. The body 10 is provided in its rear part with a bumper 12, also represented sectionally. The bumper 12 is joined to the body 10 by a bumper support 14. The bumper 12 is represented with its covering removed, so that only an interior part 15 can be seen in FIG. 1. The bumper's interior 15 has a ribbed pattern and accommodates the bumper support 14 in a quadrilateral opening 16. The sides of the quadrilateral opening 16 are formed by lateral surfaces of the ribs of the bumper interior 15. A bottom surface of the quadrilateral opening 16 has in its turn an opening, so that a first end wall of the bumper support 14 abuts against an upper section 18 and a lower section 20 of the bottom surface of the cage-like, quadrilateral opening 16. The creases 26 and 28 are spaced away from the first end wall such that after the support 14 is fully inserted into the quadrilateral opening 16 they are still outside of the opening 16.

The bumper support 14 itself is in the form of a box section and is so oriented that the open sides of the box section are disposed on the right and left, in a direction from the bumper 12 toward the body 10, i.e., in the direction of an anticipated shock due to a vehicle collision. Walls 22 and 24 on top and bottom, respectively, of the support 14 are longer than its front walls and are provided each with creases 26 and 28, respectively, each running parallel to the bumper 12. The creases 26 and 28 extend over the entire width of the top wall 22 and bottom wall 24, respectively. The front wall of the bumper support is provided with a central hole.

The anticipated direction of the shock of a collision against the bumper 12 and the bumper support 14 is indicated in FIG. 1 by an arrow 30. The top wall 22 and bottom wall 24 as well as the open sides of the quadrilateral support 14 are parallel to that direction 30 and the creases 26 and 28 are perpendicular to direction 30.

When a collision occurs and consequently the bumper support is driven in direction 30, the support is selectively deformed in that the top wall 22 is folded inwardly at the crease 26 toward the bottom wall 24. Likewise the bottom wall is folded upwardly at crease 28 toward the top wall. The bumper support 14, on the other hand, is extremely stiff perpendicularly to the collision direction 30, so that no deflection of the bumper 12 in the lateral direction needs to be feared. Any upward movement of the upper wall 22 or any downward movement of the bottom wall 24 is prevented by the quadrilateral opening 16. Since the top wall 22 and the bottom wall 24 are abutted against the interior lateral surfaces of the quadrilateral opening 16, they cannot shift downward or upward, but are folded toward one another.

The bumper support 14 is fastened to the motor vehicle body 10 by a central bolt 32.

In the perspective representation in FIG. 2, the ribbed pattern of the inner portion 15 of the bumper 12 can easily be seen. It is likewise easy to see that the bumper support 14 is partially contained in the quadrilateral opening 16, and that the top wall 22 and the bottom wall 24 of the bumper support 14 are in contact with the lateral surfaces of the opening 16.

A second end wall 34 of the box-shaped bumper support 14, which is flat and is perpendicular to the anticipated direction 30 of the thrust from a collision lies on a front-end surface of the motor vehicle body 10 which is likewise perpendicular to the said direction 30. This provides a reliable support of the bumper support 14 in the direction of the anticipated thrust 30. The flat end surface against the body 10 is formed by the end surface of a projection 36 the motor vehicle body 10 which runs contrary to the direction of thrust 30. On account of the projection 36 the vehicle body 10 is locally stiffened, so that in case of a light collision of the vehicle, only the bumper support 14, not the vehicle's body 10, is deformed. The bumper support 14 is designed so that the rear end metal of the body 10 on which the projection 36 is located, escapes damage up to collision velocities of 15 km/h.

The fragmentary sectional drawing in FIG. 3 shows the bumper support 14 which is fastened by the bolt 32 to the motor vehicle body 10, the bumper interior portion 15, and a bumper covering 38 placed on the bumper interior 15. The bumper covering 38 and the motor vehicle body 10 are represented in a fragmentary cross section.

The body 10 has a central hole in the face 40 of the projection 36, through which the bolt 32 passes. In the second end wall 34 of the bumper support 14 the bolt 32 is likewise fastened in a central hole. The diameter of the second hole in the face 40 of body 10 amounts to about twice the diameter of bolt 32. In this manner dimensional differences between the body 10 and bumper 12 can be compensated.

In the sectional view of FIG. 3 the quadrilateral opening 16 can clearly be seen, into which a portion of the bumper support reaches, which extends from its wall remote from the body 10 up to the creases 26 and 28. In this section the bumper support 14 is fastened by means of an additional bolt 41 and a cotter 42 to the bumper interior portion 15. Also it is easily seen that the top wall 22 and bottom wall 26 are in contact with a lateral surface of the quadrilateral opening 16. The end wall of the bumper support 14 remote from the body 10 lies against the sections 18 and 20 of the bottom surface of the quadrilateral opening 16. In this manner any upward or downward deflection of the top wall 22 and bottom wall 26 in the event of a collision is forestalled and the bumper support 14 is given a controlled deformation.

It is to be noted in this connection that when, in the event of a collision, the top wall 22 folds downwardly toward the bottom wall 26, it breaks away from the cotter 42. The bottom wall, however, is held on the bumper support 14 even in the event of a collision. Therefore, even in a collision it is not to be feared that the bumper 12 will separate from the body 10.

The perspective view in FIG. 4 shows the bumper's interior part 15 and the bumper support 14 after a moderate collision. It can be seen that the top wall 22 of the support 14 has folded downward at the crease 26 and the bottom wall 26 has folded upward at the crease 38. The energy of the collision is thus converted to a substantially controlled deformation of the bumper support 14. The bumper interior 15 and the body 10 (not shown) have remained unharmed. It is needed only to replace the deformed bumper support 14 on order to remedy the consequences of the collision.

1. Bumper support for the attachment of a vehicle bumper (22) to a motor vehicle body (10), the bumper support (14) being configured as an energy absorbing, deformable metal part and provided with creases, characterized in that the bumper support (14) is in the shape of a box section.

2. Bumper support according to claim 1, characterized in that the bumper support (14) is configured as a part to be bent.

3. Bumper support according to claim 1 or 2, characterized in that the creases (26, 28) are provided on two opposite walls (22, 26) of the box section metal part and extend between the open sides of the box section metal part over the entire width of these walls (22, 26).

4. Vehicle bumper support with a base body (15) and a bumper support (14) according to any of the foregoing claims, characterized in that the base body (15) has a substantially quadrilateral opening (16) in which the box section metal part of the bumper support (14) is received sectionally, the open sides of the box section metal part being disposed substantially parallel to an anticipated collision direction (30), a first face wall of the box section metal part that is substantially perpendicular to the anticipated collision direction (30) being in contact at least sectionally with a bottom surface (18, 20) of the opening (16) and the walls (22, 26) of the box section metal part lying substantially parallel to the anticipated collision direction (30) and provided with creases (26, 28) are in contact at least section-wise with lateral surfaces of the quadrilateral opening (16).

5. Motor vehicle bumper according to claim 4, characterized in that the base body (15) is configured cage-wise in the area of the quadrilateral opening (16).

6. Motor vehicle with a bumper (12) according to any of the foregoing claims, characterized in that the vehicle body (10) has in the bumper area at least one planar surface (40) perpendicular to the anticipated collision direction (30), whereas a second end wall (34) likewise substantially perpendicular to the anticipated collision direction (30) is in planar contact with the planar surface (40).

7. Motor vehicle according to claim 6, characterized in that the at least one planar surface (40) is provided on a projection (36) extending substantially contrary to the anticipated collision direction (30).

8. Motor vehicle according to claim 6 or 7, characterized in that the surface (40) is provided with a first bore and the second face wall (34) of the box section metal part is provided with a second bore for the arrangement of a bolt (32), while the first and/or the second bore are so dimensioned that the bolt (32) can be contained with greater free play in the first and/or second bore.

9. Motor vehicle according to claim 8, characterized in that the diameter of the first bore is in the area of twice the diameter of the bolt (32).
